(19) United States
(12) Patent Application Publication
(10) Pub. No.: US 2016/0059230 A1
(43) Pub. Date: Mar. 3, 2016

(54) BIOCHIP PACKAGE

(71) Applicant: Silicon Optronics, Inc., Hsinchu (TW)

(72) Inventor: Chi-Hsing HSU, New Taipei City (TW)

(21) Appl. No.: 14/516,077

(22) Filed: Oct. 16, 2014

(30) Foreign Application Priority Data
Sep. 2, 2014 (TW) 103130203

(51) Int. Cl. B01L 3/00; G01N 27/447

(52) U.S. Cl. CPC B01L 3/502; G01N 27/44791; B01L 2200/10; B01L 2300/0887; B01L 2300/12; B01L 2300/165; B01L 2400/0424; B01L 2400/082

(57) ABSTRACT

A biochip package includes: (a) a bottom plate including a bottom substrate, a first electrode layer disposed on the bottom substrate and a first hydrophobic layer disposed on the first electrode layer; (b) a top plate including a top substrate and a second hydrophobic layer disposed on the top substrate, wherein the first hydrophobic layer and the second hydrophobic layer are oppositely disposed and spaced from each other to form a liquid channel; (c) a control unit connected to the first electrode layer for operating a fluid in a first direction; (d) at least one biochip disposed over the bottom plate by connecting pillars to allow the fluid to flow between the at least one biochip and the bottom plate.

### CROSS REFERENCE TO RELATED APPLICATIONS

This application claims priority of Taiwan Patent Application No. 103130203, filed on Sep. 2, 2014, the entirety of which is incorporated by reference herein.

### BACKGROUND OF THE INVENTION

1. Field of the Invention

The present invention relates to a biochip package, and in particular it relates to a biochip package with a microfluid operation system.

2. Description of the Related Art

Biochips utilize micro-electro-mechanical systems (MEMS) technologies to implant probes in chips, and then biochips may conduct various biochemical analyses based on characteristic biology conjunctions. The subjects used in biochips include: genes, proteins, cells or tissues. Biochips can be applied to fields such as biomedical research, disease diagnosis, food pathogen detection, environmental analysis and characterization, etc. The biochip industry is flourishing due to the advantages of biochips being portable, highly sensitive and specific, providing a quick analysis and requiring only small quantities of samples and agents.

However, there are many steps involved in biochemistry analyses such as sample preparations, reactions and sample analyses, etc. It would be convenient if all the elements which are needed in the analyses can be integrated in one biochip package such that the analysis processes can be completed by transferring the samples or the agents within the liquid channel which is connected with all the elements. Therefore, the primary purpose for biochip researches is to develop devices with simple structures to facilitate the transport and control of microfluids.

### BRIEF SUMMARY OF THE INVENTION

An embodiment of the present invention provides a biochip package, which includes: (a) a bottom plate, comprising: a bottom substrate; a first electrode layer disposed on the bottom substrate; and a first hydrophobic layer disposed on the first electrode layer; (b) a top plate, comprising: a top substrate; and a second hydrophobic layer disposed on the top substrate; wherein the first hydrophobic layer and the second hydrophobic layer are oppositely disposed and spaced from each other to form a liquid channel; (c) a control unit connected to the first electrode layer for operating a fluid in a first direction; and (d) at least one biochip disposed over the bottom plate by the connecting pillars to allow the fluid to flow between the at least one biochip and the bottom plate.

### BRIEF DESCRIPTION OF THE DRAWINGS

The present invention can be more fully understood by reading the subsequent detailed description and examples with references made to the accompanying drawings, wherein:

FIGS. 1A-1B are schematic drawings of biochip packages in some embodiments of the present invention.

FIG. 2 is a cross-sectional view of a biochip package in accordance with an exemplary embodiment of the present invention.

FIGS. 3A-3I are schematic drawings of fluid operations in accordance with an exemplary embodiment of the present invention.

FIG. 4 is a cross-sectional view of another biochip package in accordance with an exemplary embodiment of the present invention, wherein the biochip package includes a second electrode layer disposed in the top plate.

FIG. 5 is a cross-sectional view of another biochip package in accordance with an exemplary embodiment of the present invention, wherein the biochip package includes a second electrode layer disposed in the bottom plate.

FIG. 6 is a top view of yet another biochip package in accordance with an exemplary embodiment of the present invention, wherein the biochip package includes a plurality of biochips.

### DETAILED DESCRIPTION OF THE INVENTION

The present invention can be more fully understood by reading the subsequent detailed description and examples with references made to the accompanying drawings. It should be appreciated, however, that the present disclosure provides many applicable inventive concepts that can be embodied in a wide variety of specific contexts. The specific embodiments discussed are merely illustrative of specific ways to make and use the disclosed subject matter, and do not limit the scope of the different embodiments. In addition, the present invention may repeat reference numerals and/or letters in the various examples. This repetition is for the purpose of simplicity and clarity and does not in itself dictate a relationship between the various embodiments and/or configurations discussed.

Specific examples of components and arrangements are described below to simplify the present invention. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact.

Moreover, according to common practice, the various features of the drawings are not necessarily drawn to scale. On the contrary, the dimensions of the various features are arbitrarily expanded or reduced for clarity. Moreover, the elements which are not shown or illustrated in the figures can be any suitable form known by a person having ordinary skill in the art.

The “fluid” described herein is referred to as any kind of liquids such as samples or agents, which are desired to be processed, for example, purification, treatments, analyses, with the biochips. The “fluid” described herein may have any suitable form such as a droplet. Therefore, the “fluid” and “droplet” described herein may have the same meaning or concept.

The “fluid operation” or “droplet operation” described herein refer to any manipulation of the fluid or a droplet. For example, the “fluid operation” or “droplet operation” may include: disposing fluid or loading fluid on the biochip package; dispensing one or more portions of fluid from the source fluid; splitting, separating or dividing a fluid into two or more portions of fluid; transporting fluid from one location to another in any direction; merging or combining two or more portions of fluid into a single portion of fluid; diluting the fluid; mixing the fluid; agitating the fluid; deforming the fluid; other fluid operations described herein; and/or any combination of the foregoing.

The terms “dispensing,” “splitting,” “separating” and “dividing” the fluid described above are used to describe the creation of two or more portions of fluid from one portion of fluid or the creation of two or more droplets from one droplet. For example, “dividing droplet A into droplet B and droplet C,” can be achieved by transporting a portion of droplet A to another location (i.e., the portion of droplet A which is retained at the original location is viewed as droplet B, and the other portion of droplet A which is transferred to another location is viewed as droplet C), wherein the size of the resulting droplets can be the same or different.

The terms “merging” and “combining” the fluid described above are used to describe the creation of one portion of fluid from two or more portions of fluid or the creation of one droplet from two or more droplets. For example, “merging droplet A with droplet B,” can be achieved by transporting droplet A into contact with droplet B or transporting droplet B into contact with droplet A.

“Activate” with reference to one or more electrodes described herein is referred to as effecting a change in the electrical state of the one or more electrodes which results in fluid operation.

The present application provides a biochip package and the method of forming the same. The biochip package comprises the structures and the devices for controlling the transport of the microfluid, which may be used to achieve the purpose of microfluid operation in the biochip such that the fluid will be transferred to different regions of the biochip package to proceed with various processes such as treatments or analyses.

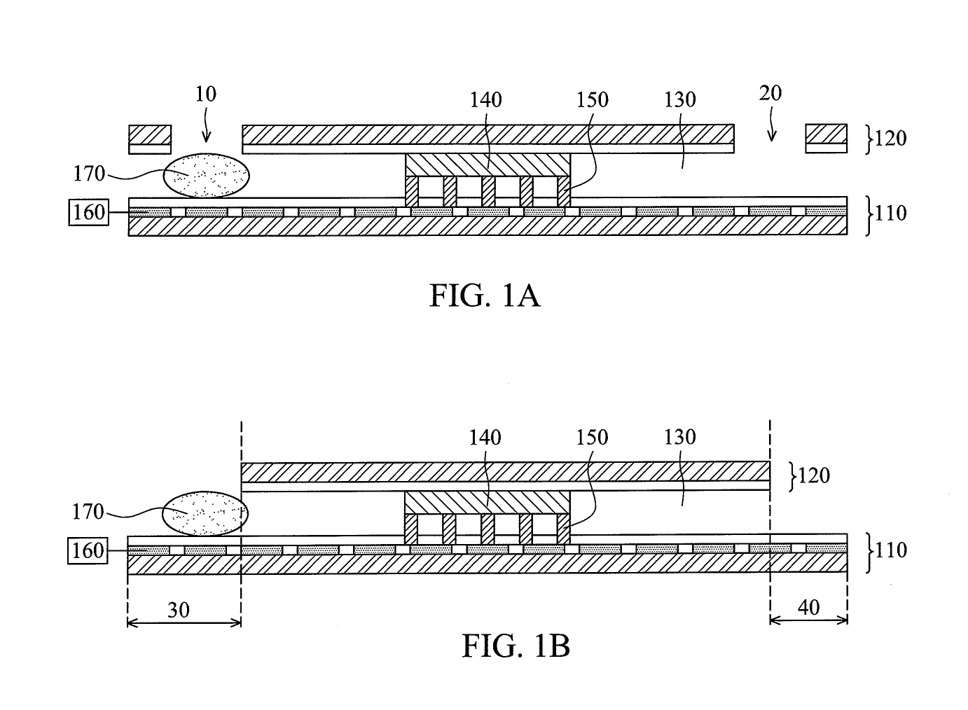

FIGS. 1A-1B are schematic drawings of biochip packages in some embodiments of the present invention. As shown in FIGS. 1A-1B, the biochip package of this embodiment primarily includes: the bottom plate 110, the top plate 120, the liquid channel 130, at least one biochip 140, the connecting pillars 150 and the control unit 160. A person with ordinary skill in the art will readily understand that the openings can be disposed on the biochip package according to the requirements of loading or removing the fluid for treatments or analyses. The following are some exemplary embodiments of an opening design for loading or removing the fluid with reference to FIGS. 1A-1B.

As shown in FIG. 1A, in one embodiment, inlet 10 and outlet 20 can be holes disposed on the top plate 120. The fluid 170 can be directed into the liquid channel 130 from the inlet 10 and be removed from the outlet 20 after completing all the processes such as treatments or analyses. In some embodiments, a fluid reservoir (not shown) can be disposed at the inlet 10 as the fluid source.

In another embodiment, as shown in FIG. 1B, the top plate 120 is smaller than the bottom plate 110 such that regions 30/40 of the bottom plate 110, which are extended over the top plate 120, can be used to load or remove the fluid. For example, the fluid 170 can be loaded at region 30 and be removed from region 40 after completing all the processes such as treatments or analyses. As described above, a fluid reservoir (not shown) can be disposed at region 30 as the fluid source.

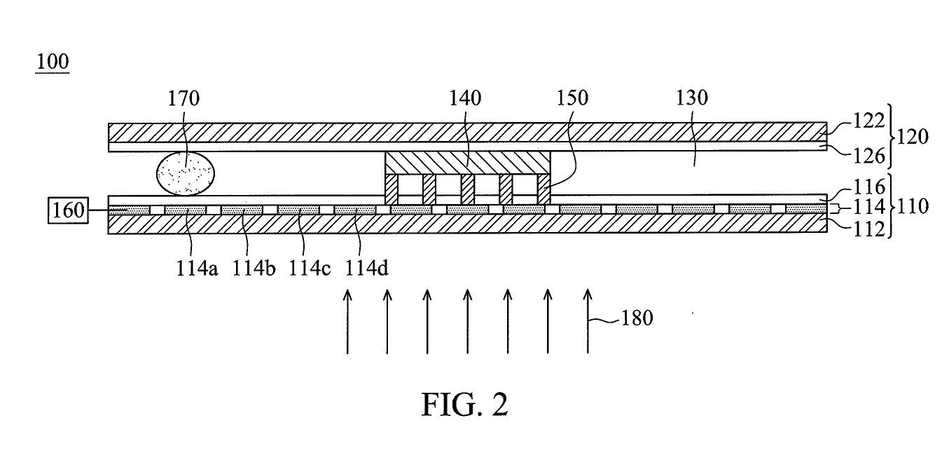

The opening design of the biochip package is not shown in the following figures for simplicity. FIG. 2 is a cross-sectional view of the biochip package 100 in an embodiment of the present invention. As shown in FIG. 2, the biochip package 100 of this embodiment primarily includes: the bottom plate 110, the top plate 120, the liquid channel 130, at least one biochip 140, the connecting pillars 150 and the control unit 160. The bottom plate 110 and the top plate 120 are oppositely disposed and spaced a distance (i.e., the liquid channel 130) from each other to allow the fluid to flow between the bottom plate 110 and the top plate 120. At least one biochip 140 is disposed over the bottom plate 110 by a plurality of connecting pillars 150, wherein the biochip 140 and the bottom plate 110 are spaced a distance from each other to allow the fluid to flow between the biochip 140 and the bottom plate 110. The control unit 160 is connected to at least one of the bottom plate 110 or the top plate 120 for operating the fluid 170 on the surface of the bottom plate 110 or in the liquid channel 130.

A more detailed descriptions of the structure of the biochip package 100 is provided as follows with reference to FIG. 2. As shown in FIG. 2, in one embodiment, the bottom plate 110 includes: the bottom substrate 112, the first electrode layer 114 and the first hydrophobic layer 116. The bottom substrate 112, the first electrode layer 114 and the first hydrophobic layer 116 are subsequently disposed as a stack structure. For example, the first electrode layer 114 is disposed on the bottom substrate 112, and the first hydrophobic layer 116 is disposed on the first electrode layer 114.

As shown in FIG. 2, in one embodiment, the top plate 120 includes: the top substrate 122 and the second hydrophobic layer 126. The top substrate 122 and the second hydrophobic layer 126 are also subsequently disposed as a stack structure. For example, the second hydrophobic layer 126 is disposed on the top substrate 122. Moreover, the first hydrophobic layer 116 of the bottom plate 110 and the second hydrophobic layer 126 of the top plate 120 are oppositely disposed with a gap to form the liquid channel 130.

The materials of the bottom substrate 112 and the top substrate 122 are the same or different. In some embodiments, the bottom substrate 112 and the top substrate 122 can be any suitable substrate, for example, glass substrates, silicon substrates, metal substrates, printed circuit board (PCB), thermoplastic substrates or flexible substrates. In one embodiment, for the optical methods of analysis, the bottom substrate 112 is a transparent substrate composed of, for example, glass, poly(methyl methacrylate) (PMMA), silicone or epoxy.

The first electrode layer 114 includes a plurality of conductive electrodes separated from each other, for example, the electrodes 114a-114d. Various fluid operations can be conducted by applying the voltage to the electrodes or not (activated/deactivated). A person with ordinary skill in the art will readily understand that the shape or the size of the electrodes can be determined according to the required loading volume of the fluid, and the arrangement of the electrodes can be determined according to the required moving path of the fluid.

The first electrode layer 114 may include any suitable conductive material, for example, metal materials, transparent conductive materials or the composite materials and the stack structures thereof. The metal materials include: Sn, Pb, Cu, Al, Au, Ag or alloys thereof. The transparent conductive materials include: indium tin oxide (ITO), indium zinc oxide (IZO), cadmium tin oxide (CdTO), aluminum-doped zinc oxide (AZO), indium tin zinc oxide, (ITZO), zinc oxide, (ZnO), cadmium oxide (CdO), hafnium oxide (HfO), indium gallium zinc oxide (InGaZnO), indium gallium zinc magnesium oxide (InGaZnMgO), indium gallium magnesium oxide (InGaMgO) or indium gallium aluminum oxide (InGaAlO). In one embodiment, for the optical methods of analysis, the first electrode layer 114 is a transparent electrode layer composed of the transparent conductive materials.

The method of forming the first electrode layer 114 on the bottom substrate 112 include: physical vapor deposition (PVD) such as metal evaporation or sputtering; chemical vapor deposition (CVD) such as metal organic CVD (MOCVD), plasma enhanced CVD (PECVD), an atmospheric pressure CVD (APCVD), low pressure CVD (LPCVD), high density plasma CVD (HDPCVD), atomic layer CVD (ALCVD); and/or combinations thereof.

The first hydrophobic layer 116 and the second hydrophobic layer 126 may maintain a ball shape (i.e., the droplet form) and reduce the surface adhesion of the fluid 170 with surface tension, which may reduce the force (i.e., reduce the applied voltage) needed for operating the fluid 170 which is controlled by the control unit 160. The materials of the first hydrophobic layer 116 and the second hydrophobic layer 126 are the same or different.

In some embodiments, the first hydrophobic layer 116 and the second hydrophobic layer 126 are independently the fluorinated hydrophobic coating, the silicone coating or the organic hydrophobic coating.

The first hydrophobic layer 116 and the second hydrophobic layer 126 can be formed by any suitable method. For example, the hydrophobic materials can be dissolved and formed as a solution first. After the solution is coated by dip coating or spin coating, the first hydrophobic layer 116 and the second hydrophobic layer 126 are formed by removing the solvent.

As shown in FIG. 2, in one embodiment, the biochip 140 is disposed over the bottom substrate 112 by the connecting pillars 150, and the reactive region of the biochip 140 faces toward the bottom substrate 112 such that there is a gap between the reactive region of the biochip 140 and the bottom substrate 112.

The biochips are used for fluid treatments or analyses. A person with ordinary skill in the art will readily understand that the biochips can be any suitable biochip according to requirements. For example, the biochip may perform the processes such as the pre-treatment of the sample, the process of mixing, transferring, purifying, separating, characterization or detection. In one embodiment, the biochip 140 are gene chips such as gene microarrays, DNA chips or PCR chips, the protein chips, the carbohydrate chips, the cell-based microarrays, microfluidic chips, microarray chips or the Lab-on-chips.

The connecting pillars 150 are used to level the biochip 140 up, and form the electrical connection between the biochip 140 and the first electrode layer 114. The signals detected by the biochip 140 can be transferred to outside through the electrical connection formed by the connecting pillars 150 between the biochip 140 and the first electrode layer 114. In one embodiment, the connecting pillars 150 penetrate through the first hydrophobic layer 116 and are electrically connected to the first electrode layer 114.

The connecting pillars 150 can be any suitable connecting structure, and the connecting pillars 150 may have any suitable shape or structure. For example, the shape of the connecting pillars 150 may include pillars or balls. The structures of the connecting pillars 150 may include Au studs, solder balls or bumps. The connecting pillars 150 may include any suitable conductive material, for example, Sn, Pb, Cu, Al, Au, Ag or an alloy thereof.

The connecting pillars 150 can be formed on the bottom substrate 112 by any conventional method. For example, the openings can be formed in the first hydrophobic layer 116 to expose the first electrode layer 114 first, and then the connecting pillars 150 can be formed in the openings such that the first electrode layer 114 and the biochips 140 are electrically connected with the connecting pillars 150. In one embodiment, a protection layer is formed outside the surface of the connecting pillars 150 to avoid reactions between the fluid 170 and the connecting pillars 150.

In one embodiment, the biochip 140 is further fixed on the second hydrophobic layer 126. The biochip 140 can be fixed on the second hydrophobic layer 126 by any conventional method. For example, the biochip 140 is fixed on the second hydrophobic layer 126 through an adhesive layer (not shown), wherein the adhesive layer includes silicone, epoxy, polyacrylate, synthetic resin or polyurethane (PU).

As shown in FIG. 2, in one embodiment, the reactive region of the biochip 140 faces toward the first hydrophobic layer 116, and the fluid 170 flows between the biochip 140 and the bottom plate 110. In one embodiment, the light source 180 for fluid analysis is irradiated from the bottom plate 110 toward the biochip 140. As described above, for the optical methods of analysis, both the bottom substrate 112 and the first electrode layer 114 are composed of transparent materials such that the light source 180 can penetrate through the bottom substrate 112 and the first electrode layer 114 to proceed with the analysis when the fluid 170 flows between the reactive region of the biochip 140 and the bottom substrate 112.

In some embodiments, the optical methods of analysis include: emission and absorption spectral analysis or transmission and reflection spectral analysis. In some embodiments, the optical methods of analysis are, for example, UV-Vis spectroscopy, IR spectroscopy, fluorescence spectroscopy or Raman spectroscopy. In some embodiments, light source 180 includes: IR, visible light, UV or X ray.

As shown in FIG. 2, in one embodiment, the control unit 160 is connected to the first electrode layer 114 of the bottom plate 110 for operating the fluid 170 in a first direction. The control unit 160 is used to control a plurality of conductive electrodes (the electrodes 114a-114d) which are separated from each other in the first electrode layer 114, to achieve the purpose of operating the fluid 170. More specifically, the conductive electrodes can be activated by applying voltage or the conductive electrodes can be deactivated by removing the voltage thereon for conducting the fluid operation.

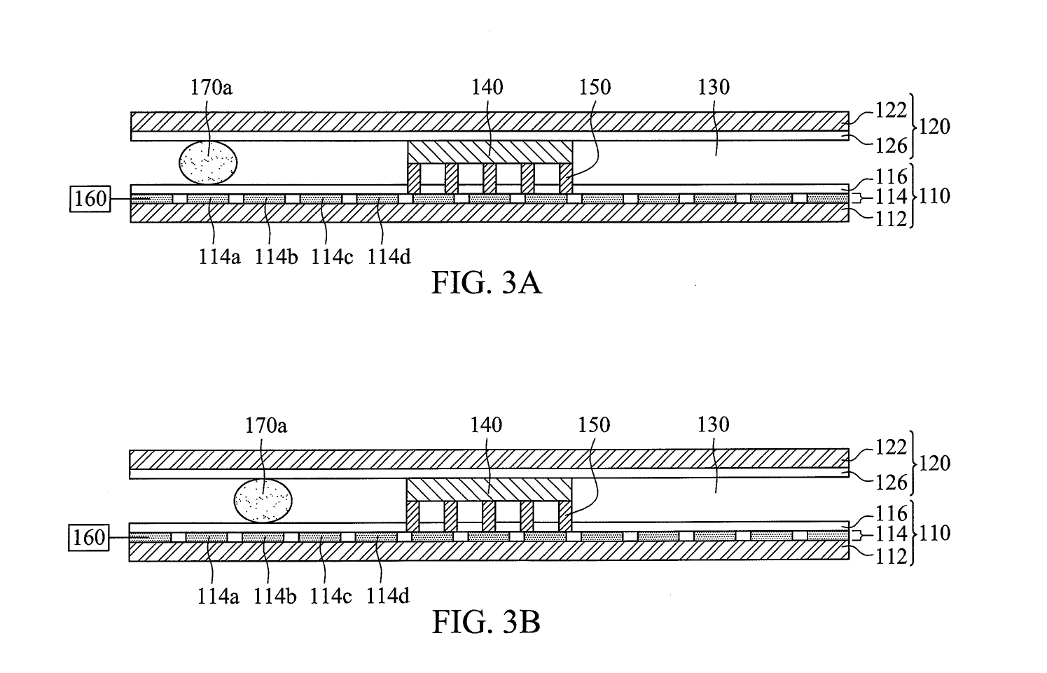

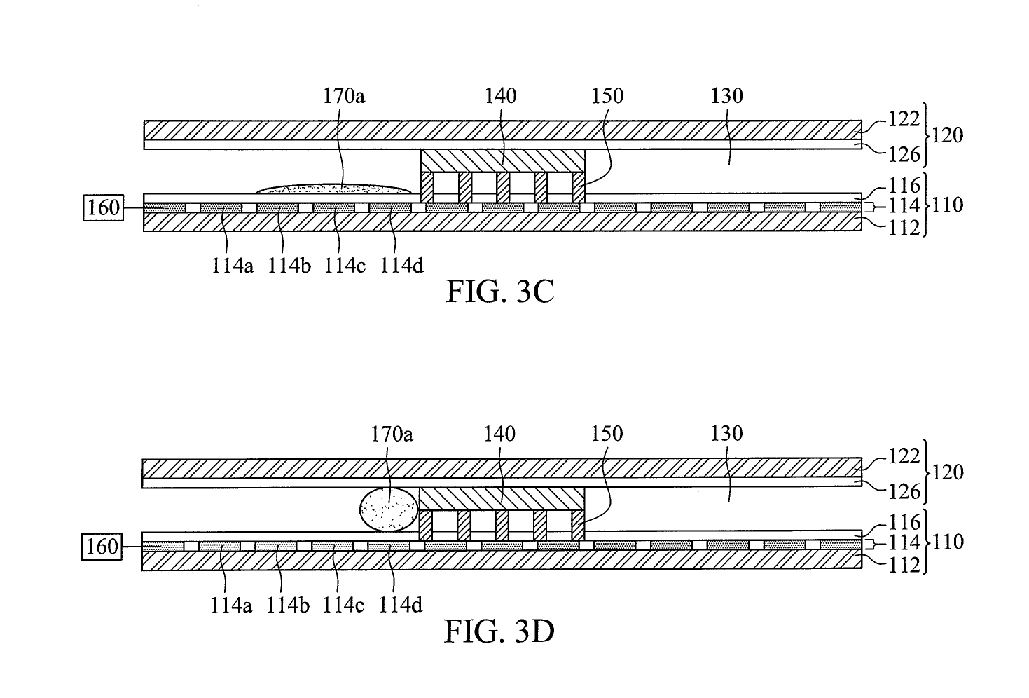

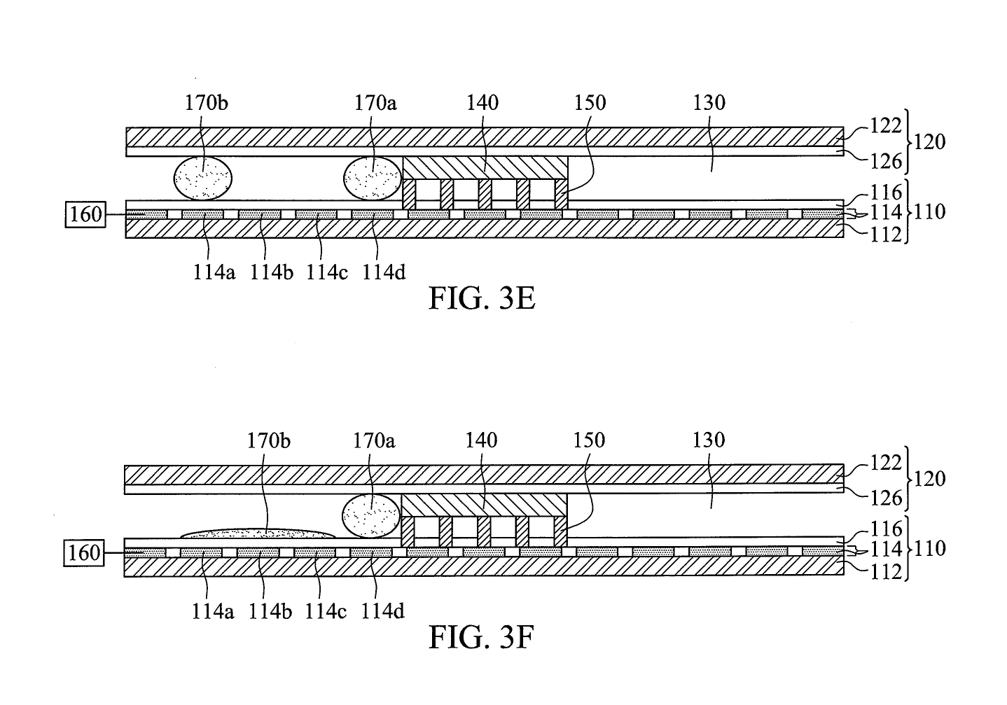

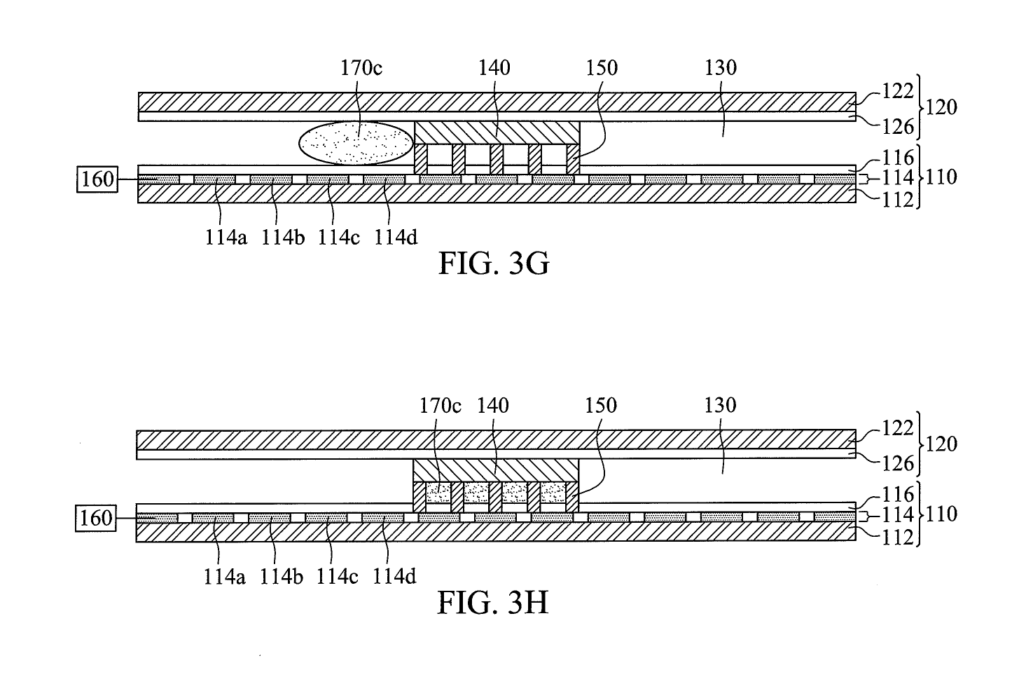

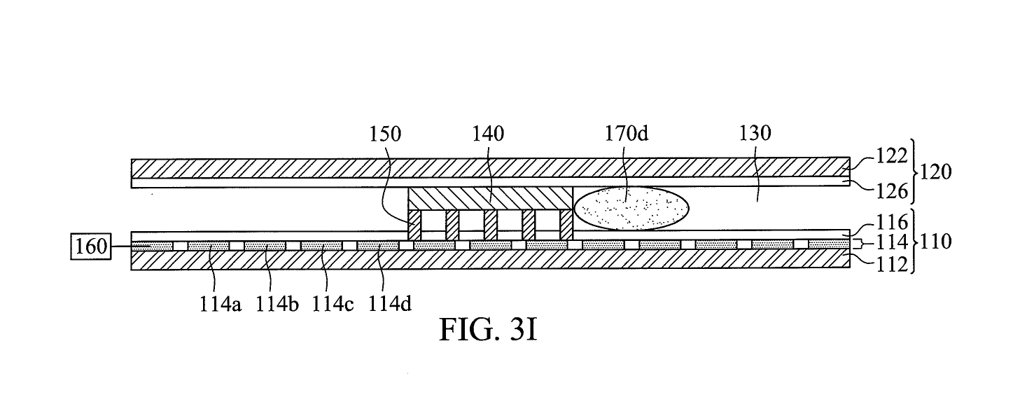

The following illustrates an embodiment of the fluid operation of the present application in accordance to FIGS. 3A-3I. As shown in FIG. 3A, the electrode 114a can be activated to separate the droplet 170a from the source fluid (or source droplet) (not shown), and to direct the droplet 170a into the liquid channel 130. At this time, the droplet 170a is on the electrode 114a. As shown in FIG. 3B, in order to transport the droplet 170a, the electrode 114b can be activated and the electrode 114a can be subsequently deactivated to transfer the droplet 170a to the electrode 114b. As shown in FIG. 3C, the electrode 114c and the electrode 114d can be subsequently activated to further draw the droplet 170a toward the electrodes 114c and 114d into the liquid channel 130, wherein the droplet 170a is deformed. And then, as shown in FIG. 3D, the droplet 170a will be transferred to the electrode 114d after the electrode 114b and the electrode 114c are deactivated.

As shown in FIG. 3E, the electrode 114a can be re-activated to separate the droplet 170b from the source fluid (not shown). Then, as shown in FIG. 3F, the electrode 114b and the electrode 114c are subsequently activated to deform and dispense the droplet 170b on the electrodes 114a, 114b and 114c. As shown in FIG. 3G, after the electrode 114a and the electrode 114b are deactivated, the droplet 170b will be transferred to the electrode 114c and contact the droplet 170a on the electrode 114d causing the droplet 170c to be formed by the combination of the droplet 170a and the droplet 170b.

As shown in FIG. 3H, the droplet 170c is transferred between the biochip 140 and the bottom plate 110 according to the methods of electrode activating/deactivating described above, and the droplet 170c will contact the reactive region of the biochip 140 to proceed with reactions. As shown in FIG. 3E, the droplet 170d will be transferred away from the biochip 140 after the reactions and go on with the subsequent analytical processes.

A person with ordinary skill in the art will readily understand that the fluid can be dispersed on one or more electrodes with appropriate operations. Also, the fluid volume reacted with the biochip can be controlled with the size of the electrodes. Moreover, the fluid volume reacted with the biochip can be controlled with the voltage applied to the electrodes.

It should be noted that, in the conventional biochip package, the biochip is disposed on the surface of the bottom substrate (the reactive region of the biochip faces toward the top plate), and the fluid must be raised to a certain height, for example, the thickness of the biochip, to transfer the fluid to the reactive region of the biochip. However, a higher voltage is needed to raise the height of the fluid, which may cause damages to the biochips. Compared to that, the biochip in the biochip package of the present application is raised level with the connecting pillars, and the reactive region of the biochip faces toward the bottom plate such that the fluid will readily react with the reactive region of the biochip when it flows between the bottom plate and the biochip. Therefore, the fluid can only flow on a horizontal plane without changing the height level, which may avoid damaging the biochips and may help the fluid flowing through the reactive region steadily and smoothly.

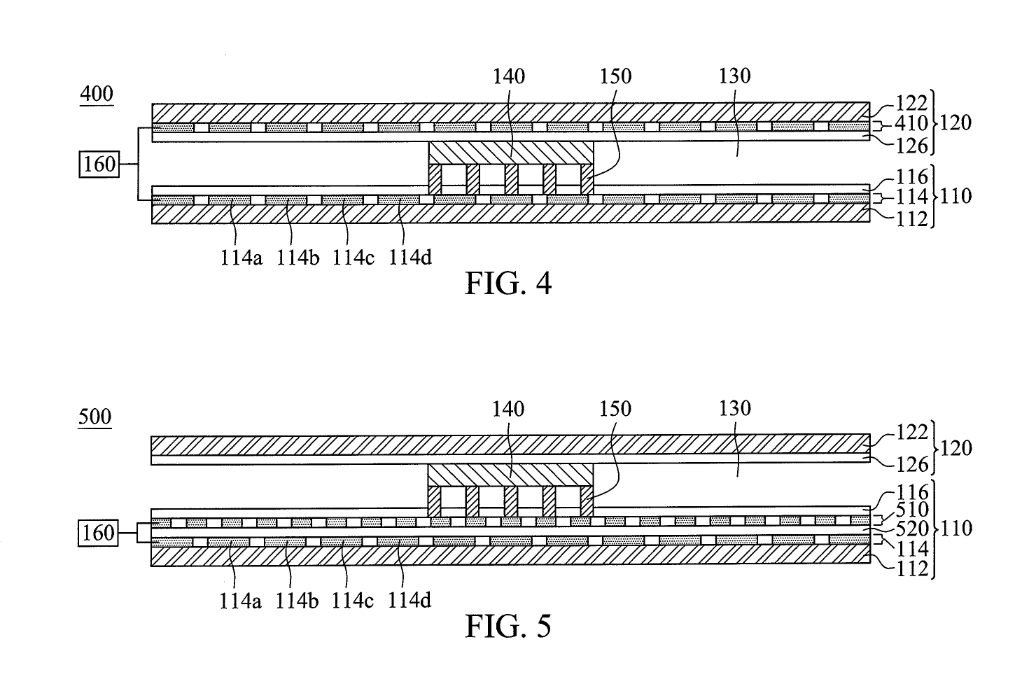

FIG. 4 is a cross-sectional view of biochip package 400 in accordance with an exemplary embodiment of the present invention, wherein the biochip package includes a second electrode layer disposed in the top plate. The biochip package 400 and the biochip package 100 are substantially the same; however, the top plate 120 of the biochip package 400 further includes the second electrode layer 410.

Referring to FIG. 4, in one embodiment, the second electrode layer 410 is disposed between the top substrate 122 and the second hydrophobic layer 126, wherein the control unit 160 further connects to the second electrode layer 410 for operating the fluid 170 in a second direction. In one embodiment, the first direction is different from the second direction, for example, the first direction is perpendicular to the second direction.

FIG. 5 is a cross-sectional view of biochip package 500 in accordance with an exemplary embodiment of the present invention, wherein the biochip package includes a second electrode layer disposed in the bottom plate. The biochip package 500 and the biochip package 100 are substantially the same; however, the bottom plate 110 of the biochip package 500 further includes the second electrode layer 510 and the dielectric layer 520.

Referring to FIG. 5, in one embodiment, the second electrode layer 510 is disposed between the bottom substrate 112 and the first electrode layer 114, and the dielectric layer 520 is disposed between the first electrode layer 114 and the second electrode layer 520, wherein the control unit 160 further connects to the second electrode layer 510 for operating the fluid 170 in a second direction.

The second electrode layer 410/510 are substantially the same as the first electrode layer 114, which can be formed in substantially the same manner and comprises the same materials as the first electrode layer 114. In one embodiment, for the optical methods of analysis, the second electrode layer 510 is a transparent electrode layer composed of transparent conductive materials.

As shown in FIGS. 4-5, the second electrode layer 410/510 can be disposed in the top plate or the bottom plate according to requirements. That is, the first electrode layer and the second electrode layer can be disposed in the same substrate or be disposed in the different substrates; however, a dielectric layer is disposed between the first electrode layer and the second electrode layer if the two electrode layers are disposed in the same substrate. It should be noted that both the applied voltage for operating the fluid and the fabrication cost can be reduced if the first electrode layer and the second electrode layer are disposed in the different substrates respectively (i.e., the biochip package 400).

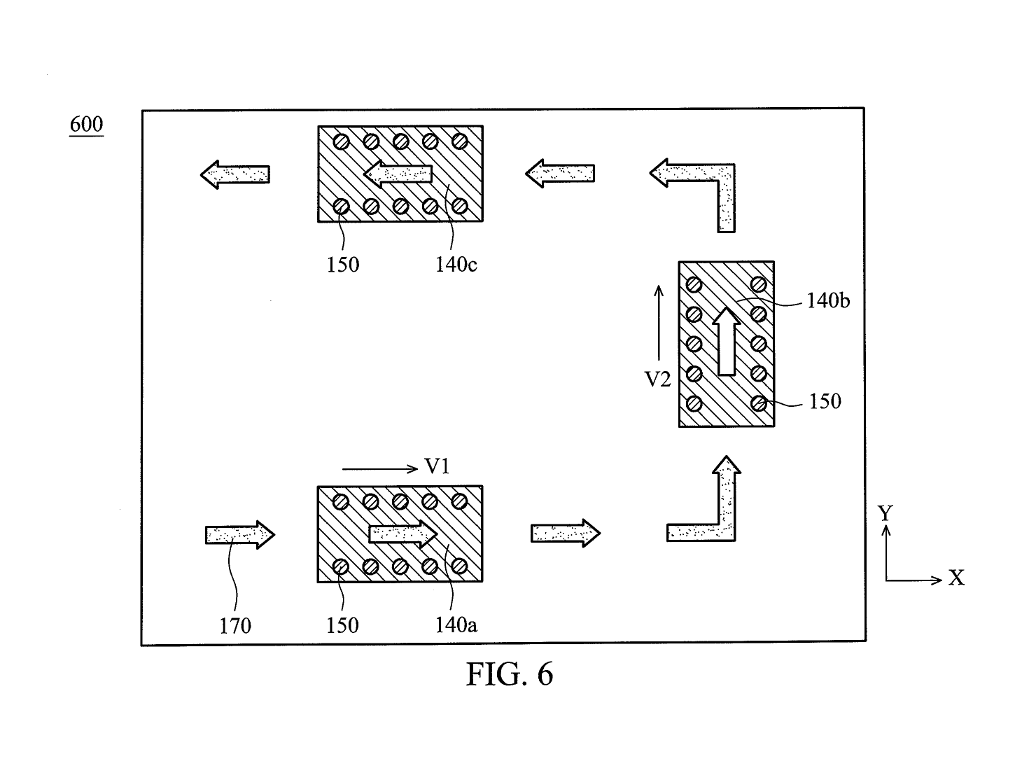

A person with ordinary skill in the art will readily understand that various elements or biochips can be arranged on the biochip package according to the requirements to conduct the treatment or the analyses of the fluid. The following illustrates an embodiment of the fluid path in accordance with FIG. 6.

FIG. 6 is a top view of yet another biochip package in accordance with an exemplary embodiment of the present invention, wherein the biochip package includes a plurality of biochips. As shown in FIG. 6, the biochip package 600 includes three biochips 140a-140c. The fluid can be operated to flow through the biochips 140a-140 with the control unit and the first electrode layer and the second electrode layer of the biochip package. For example, the fluid can be operated to transfer along the first direction V1 and flow through the biochip 140a with the control unit and the first electrode layer. Then, the fluid can be operated to transfer along the second direction V2 and flow through the biochip 140b with the control unit and the second electrode layer. Finally, the fluid can be operated to transfer along the first direction V1 and flow through the biochip 140c with the control unit and the first electrode layer. In one embodiment, the first direction V1 is the X-direction and the second direction V2 is the Y-direction, wherein the first direction V1 is perpendicular to the second direction V2.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A biochip package, comprising:
a bottom plate, comprising:
a bottom substrate;
a first electrode layer disposed on the bottom substrate; and
a first hydrophobic layer disposed on the first electrode layer;
a top plate, comprising:
a top substrate; and
a second hydrophobic layer disposed on the top substrate; wherein the first hydrophobic layer and the second hydrophobic layer are oppositely disposed and spaced from each other to form a liquid channel;
a control unit connected to the first electrode layer for operating a fluid in a first direction; and
at least one biochip disposed over the bottom plate by a plurality of connecting pillars on the bottom plate to allow the fluid to flow between the at least one biochip and the bottom plate.

2. The biochip package as claimed in claim 1, further comprising:
a second electrode layer disposed in the bottom plate or the top plate, and the control unit further connected to the second electrode layer for operating the fluid in a second direction different from the first direction.

3. The biochip package as claimed in claim 2, wherein the second electrode layer is disposed between the bottom substrate and the first electrode layer, and a dielectric layer is disposed between the first electrode layer and the second electrode layer.

4. The biochip package as claimed in claim 2, wherein the second electrode layer is disposed between the top substrate and the second hydrophobic layer.

5. The biochip package as claimed in claim 2, wherein the first direction is perpendicular to the second direction.

6. The biochip package as claimed in claim 1, wherein the connecting pillars penetrate through the first hydrophobic layer and are electrically connected to the first electrode layer.

7. The biochip package as claimed in claim 1, wherein the at least one biochip are further fixed onto the second hydrophobic layer.

8. The biochip package as claimed in claim 1, wherein a reactive region of the at least one biochip faces toward the first hydrophobic layer.

9. The biochip package as claimed in claim 1, wherein the first hydrophobic layer and the second hydrophobic layer are independently fluorinated hydrophobic coating, silicone coating or organic hydrophobic coating.

10. The biochip package as claimed in claim 3, wherein the bottom substrate is a transparent substrate, and the first electrode layer and the second electrode layer are transparent electrode layers.

11. The biochip package as claimed in claim 10, wherein the bottom substrate is glass, poly(methyl methacrylate) (PMMA), silicone or epoxy.

12. The biochip package as claimed in claim 10, wherein the first electrode layer and the second electrode layer are independently ITO, IZO, CTO, AZO, ITZO, ZnO, CdO, HfO, InGaZnO, InGaZnMgO, InGaMgO or InGaAlO.
